(19) United States
(12) Patent Application Publication
(10) Pub. No.: US 2007/0130300 A1
(43) Pub. Date: Jun. 7, 2007

(54) CONFIGURABLE MULTIMEDIA SIP CLIENT

(75) Inventors: Kevin Song, Carrollton, TX (US); Chou-Ling Ting, Plano, TX (US)

Correspondence Address: FOGG & POWERS LLC, 10 SOUTH FIFTH STREET, SUITE 1000, MINNEAPOLIS, MN, 55402, US

(73) Assignee: Samsung Electronics Co., Ltd., Suwon-city (KR)

(21) Appl. No.: 11/566,396

(22) Filed: Dec. 4, 2006

Related U.S. Application Data
(60) Provisional application No. 60/742,310, filed on Dec. 5, 2005.

(51) Int. Cl. G06F 15/177

(52) U.S. Cl. 709/222

(57) ABSTRACT

A configurable multimedia SIP client and method are disclosed. As one example, a configurable multimedia SIP client is disclosed, which includes a client user interface, a call processing configuration manager, and a configuration adaptor coupled to the client user interface and the call processing configuration manager. The configuration adaptor is operable to receive configuration information, extract user interface information and call processing functional information from the received configuration information, convey the user interface information to the client user interface, and convey the call processing functional information to the call processing configuration manager.

### FIELD OF THE INVENTION

The present invention is related to the telecommunication field, and more particularly, but not exclusively, to a configurable multimedia Session Initiation Protocol (SIP) client.

### BACKGROUND OF THE INVENTION

The SIP is an ASCII signaling protocol used to create, modify and terminate communication sessions with one or more participants. Such sessions can include Internet phone calls (e.g., VoIP), multimedia distribution, and multimedia conferences. The SIP has been accepted as a signaling protocol for the 3^{rd} Generation Partnership Project (3GPP) and is an important architectural element of the Internet Protocol (IP) Multimedia Subsystem (IMS).

Notwithstanding the numerous advantages of the SIP over other communication protocols, many problems with implementing the SIP still need to be resolved. For example, most commercially available SIP clients (e.g., User Agent clients) have different user interfaces and functionalities. This diversity exists because no pertinent standards or requirements have been defined for the numerous SIP client vendors to follow. Also, there is no SIP client currently available that can handle all of the IMS-based multimedia SIP applications that exist. Consequently, numerous problems with testing these applications using the various available SIP clients have been encountered by IMS test engineers.

For example, some SIP clients are incapable of supporting 3GPP call flows. Also, no individual SIP client is capable of supporting all multimedia and basic call control functionalities, such as IETF call flows, 3GPP call flows, and various other new services' call flows. However, the currently available test drivers (e.g., EAST, INET, etc.) are designed to run traffic-related or protocol-related test scenarios. Consequently, the existing test drivers are inadequate for testing multimedia SIP application scenarios.

Furthermore, there is no SIP client available that can satisfy all possible test conditions. For example, no individual SIP client is available that can handle all of the various SIP extensions (e.g., extensions to the base SIP specification), multimedia call functionalities, video or audio functionalities, and inconsistent call flows. All of these capabilities are required to test the various Internet multimedia services involved. In other words, there is no individual SIP client currently available that can be implemented with all possible functionalities, or that can be configured by a user so that needed functionalities can be added or removed. As a result, test engineers have to use different SIP clients from numerous different vendors in order to test all of the IP multimedia services involved. This lack of SIP client functional flexibility increases the costs of testing Internet multimedia services, because of the additional time and money expended to obtain the required functionalities from the one or more SIP client vendors involved.

### SUMMARY OF THE INVENTION

In a first example embodiment, a configurable multimedia SIP client is provided. The configurable multimedia SIP client includes a client user interface, a call processing configuration manager, and a configuration adaptor coupled to the client user interface and the call processing configuration manager. The configuration adaptor is operable to receive configuration information, extract user interface information and call processing functional information from the received configuration information, convey the user interface information to the client user interface, and convey the call processing functional information to the call processing configuration manager.

In a second example embodiment, a configurable multimedia SIP client is provided. The configurable multimedia SIP client includes a client user interface core operable to form a communication interface between a user and the multimedia SIP client, a configuration adaptor coupled to the client user interface core, wherein the configuration adaptor is operable to read computer-readable configuration setup information, and extract user interface information and call processing functional information from the computer-readable configuration setup information, and a configuration manager coupled to the client user interface core and the configuration adaptor, wherein the configuration manager is operable to receive configuration information from the configuration adaptor, and create a SIP session with a state machine.

In a third example embodiment a method for configuring a SIP client is provided. The method includes the steps of receiving SIP session configuration information, extracting user interface information and call processing functional information from the received SIP session configuration information, conveying the user interface information to a client user interface core, conveying the call processing functional information to a call processing core configuration manager, creating a state machine session with the conveyed call processing information, and creating a function key with the conveyed user interface information.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a high level architecture for a configurable SIP client, which can be used to implement an example embodiment of the present invention;

FIG. 2 depicts a block diagram showing a detailed view of a portion of the configurable SIP client depicted in the example embodiment of FIG. 1;

FIG. 3 depicts a block diagram showing a detailed view of a second portion of the configurable SIP client depicted in the example embodiment of FIG. 1; and

FIG. 4 depicts a block diagram showing a detailed view of a third portion of the configurable SIP client depicted in the example embodiment of FIG. 1.

### DETAILED DESCRIPTION OF PREFERRED EMBODIMENT

A configurable multimedia SIP client is provided, which enables users to add or remove client functionalities as desired. An Extensible Markup Language (XML) configuration adapter (XCA) subsystem is provided, which is responsible for reading XML configuration setup information, parsing out key information from the configuration setup information, and conveying the parsed information to a client user interface core and a call processing core's configuration manager. The user interface core process and call processing core configuration manager's process adopt the information conveyed from the XCA, and accordingly change the user interface and functionality. After the new configuration is applied and the client is restarted, the new interfaces and call processing functionalities are ready for operation. The XML configuration information may include one or more call control keys, one or more call flow instructions, and certain message parameters. Thus, system test personnel can add or remove pre-defined functionalities from the configurable multimedia SIP client as desired. The pre-defined function keys for call control can include, for example, such functions as re-dial, hold, music on hold, attended/unattended call transfer, three-party conference, audio/video conference, instant conference, web pushing, and the like. A system tester can create such a call control key on the configurable multimedia SIP client, and program how the SIP client core process should react to that key. In this way, the configurable multimedia SIP client provides a substantial amount of test flexibility for system test personnel. Since test personnel can add call function keys and also program call flows, virtually all service scenarios can be tested in this environment. As such, system test personnel do not have to ask the vendors of the existing SIP clients to support new functionalities or call flows, which results in significant savings in terms of the time and costs expended to accomplish the tasks involved.

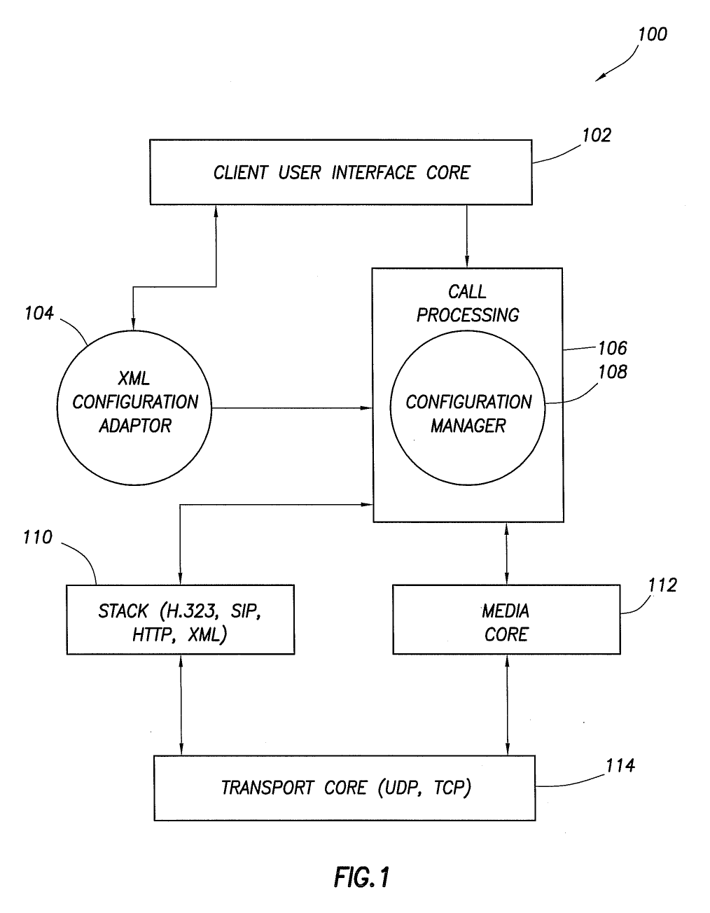

With reference now to the figures, FIG. 1 depicts a block diagram of a high level architecture for a configurable SIP client 100, which can be used to implement an example embodiment of the present invention. The architecture for the configurable SIP client 100 includes a client user interface core 102 coupled to an XML configuration adaptor 104 and a call processing core 106. For this example embodiment, a client user is a network element that sends SIP requests and receives SIP responses. More precisely, the client user interface in this example embodiment can be an interface for a user agent client, which is the portion of a user agent that initiates requests. Specifically, the user agent client is a logical entity that creates a new SIP request and uses the client transaction state machine to send the request. A user agent server can respond to the request. The client user can generate the request based on an external stimulus (e.g., a user pressing a button, a signal or tone on a PSTN line, etc.). The client user interface core 102 is a set of processing functions required of the client user interface involved. These functions reside in the protocol hierarchy above the transaction and transport layers. In this embodiment, the client user interface core 102 can receive and process the external stimulus from the user(s) involved.

For this example embodiment, the call processing core 106 provides the set of processing functions required of the call processing component of the configurable multimedia SIP client 100. The call processing core 106 provides the functions that describe how the Internet telephony call requests (e.g., invitations) should be processed. As such, the call processing core 106 includes a configuration manager 108. The configuration manager 108 provides the default call processing functions for the call processing core 106, manages the state machine configuration requests received from the XML configuration adaptor 104, and creates new functionalities based on the state configuration requests received. The configuration manager 108 is coupled to a protocol stack 110 and a media core 112. In this case, the protocol stack 110 is the set of protocols (e.g., SIP, H.323, HTTP, XML) used for decoding the new functionality data in the communications network involved. The media core 112 provides the set of functions required to process SIP media. The protocol stack 110 and media core 112 are coupled to a transport core 114. The transport core 114 provides the set of processing functions required to handle SIP messages at the transport layer, whereby the data (e.g., messages) from the protocol stack 110 and media core 114 are formed into packets in accordance with the User Datagram Protocol (UDP) or the Transmission Control Protocol (TCP).

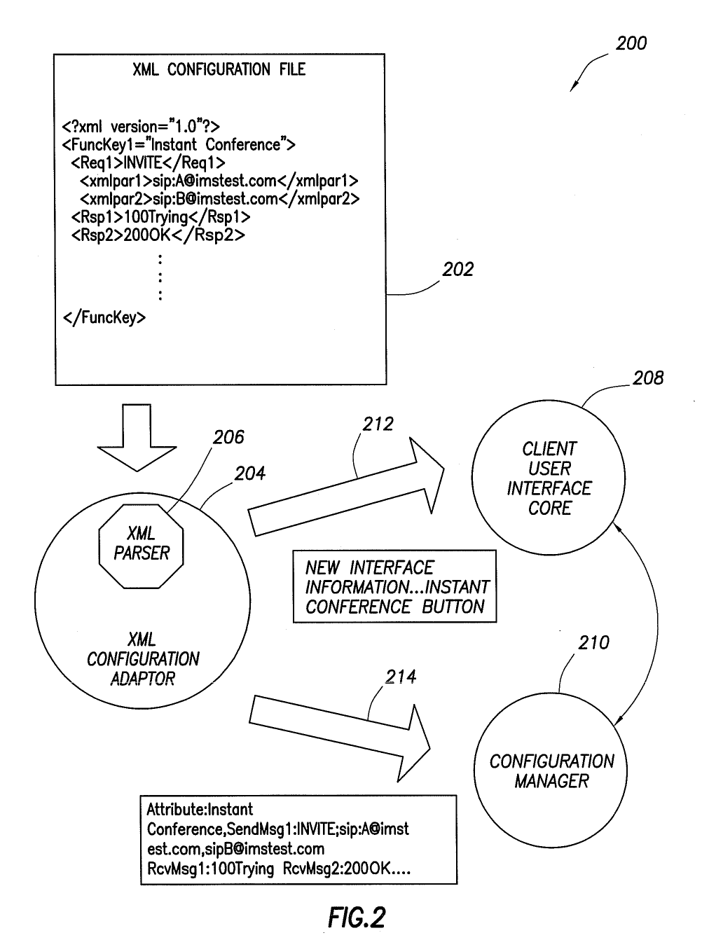

FIG. 2 depicts a block diagram 200 showing a detailed view of a portion of the configurable SIP client 100 depicted in the example embodiment of FIG. 1. For this example embodiment, FIG. 2 illustrates how the XML configuration adaptor 104 in FIG. 1 functions as a configurable interface with the client user interface core 102 and the call processing core's configuration manager 108. Referring to FIGS. 1 and 2, the XML configuration adaptor 204 receives an XML configuration file 202, which is conveyed from a user via the client user interface core 102. The XML configuration adaptor 204 includes an XML parser 206, which parses out and extracts new configuration information from the XML configuration file 202, and conveys the extracted information in an appropriate format to the client user interface core 208 and also the configuration manager 210. Notably, as an option, if a “smart” state machine is available, the state machine can create the XML configuration file automatically based on certain predefined criteria, and the user is thus not required to manually create the new XML configuration files. Also note that the present invention is not intended to be limited to the type of computer-readable language involved. For example, as an alternative, the XML configuration adaptor 204 (104 in FIG. 1) may be replaced by any suitable process that can read a configuration file, and extract or parse out important configuration information that can be conveyed in an appropriate format to a client user interface core and a call processing configuration manager, or functionally similar other SIP-compatible components.

For this example, as shown by the illustrative XML configuration file 202, a user has included new interface information that defines a new function key “Instant Conference” and a session invitation request entitled “INVITE”. The request is intended for two recipients, A and B. Also, two possible responses “Trying” and “OK” are defined for this request. The XML parser 206 parses out the “Instant Conference” function key information, and forwards that information 212 in a suitable format to the client user interface core 208. Also, the XML parser 206 parses out the remaining information (e.g., attribute information, etc.) from the XML configuration file 202, and forwards that information 214 in a suitable format to the call processing core's configuration manager 210.

FIG. 3 depicts a block diagram 300 showing a detailed view of a second portion of the configurable SIP client 100 depicted in the example embodiment of FIG. 1. For this example embodiment, FIG. 3 illustrates how the call processing core's configuration manager 302 (108 in FIG. 1) can create a new state machine session, such as, for example, an IMS Instant Conference (IC). Notably, the configurable SIP client 100 may also be used for other multimedia services, such as, for example, smart mobile or wireless phones, wireline telephony, video teleconferencing, and the like.

In any event, using the parsed information conveyed from the XML configuration adaptor 204 (FIG. 2), the call processing core's configuration manager 302 provides the default call handling processes for the newly created state machine session 304, and also manages the state configuration request received. For this illustrative example, the new state machine session is for an Instant Conference.

Additionally, once the attribute information and necessary message parameters (214 in FIG. 2) are received from the XML configuration adaptor 204, the call processing core's configuration manager 302 creates a new state machine session 304 to handle the call flow for the service involved. The new state machine session 304 remains in an idle state until a suitable event notification message is received from the client user interface core process 102. Once such an event notification message is received, the new state machine session 304 is switched to an active state.

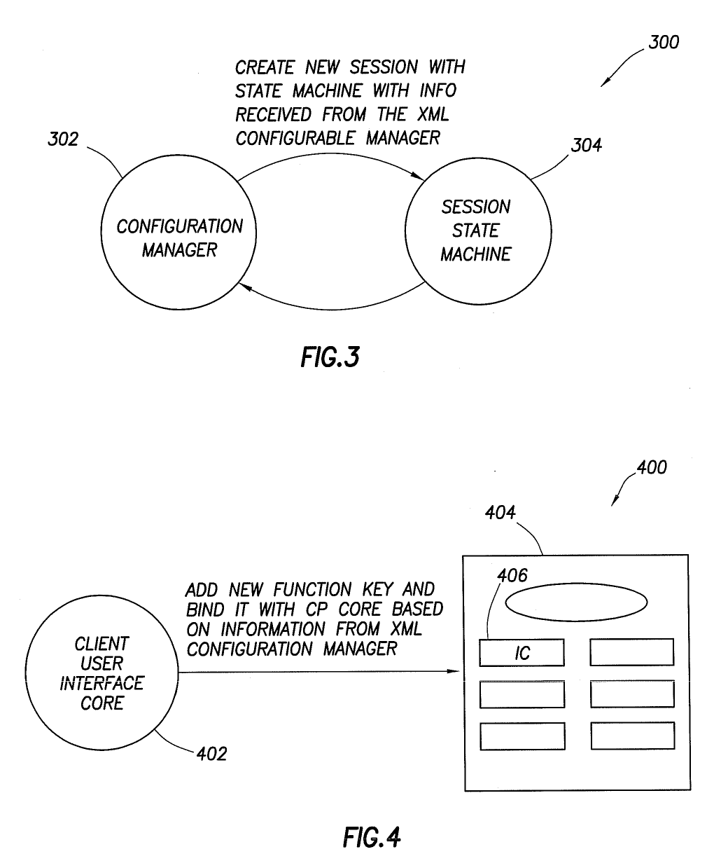

FIG. 4 depicts a block diagram 400 showing a detailed view of a third portion of the configurable SIP client 100 depicted in the example embodiment of FIG. 1. For this example embodiment, FIG. 4 illustrates how the client user interface core 402 (102 in FIG. 1) can create a new SIP client interface panel for the state machine involved. For example, the client user interface core process 402 receives new configuration information (212 in FIG. 2) from the XML configuration adaptor 204 (FIG. 2). The new configuration information may include a function key name (e.g., Instant Conference or IC) 406 and pertinent location information (e.g., IP address, etc.). The client user interface core process 402 creates a new SIP client interface panel 404 with the new function key name (IC) and the location information. In other words, the client user interface core 402 creates an IC “button” associated with that new function key. Also, the client user interface core process 402 binds the new function key with the call processing core (106 in FIG. 1) based on the information received from the XML configuration adaptor (204), in order for the configuration manager (108) to receive the event notification message when the new function key is activated (e.g., pressed by a user), and convey the event notification message to the state machine session involved.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A configurable multimedia SIP client, comprising:
a client user interface;
a call processing configuration manager; and
a configuration adaptor coupled to the client user interface and the call processing configuration manager, wherein the configuration adaptor is operable to:
receive configuration information;
extract user interface information and call processing functional information from the received configuration information;
convey the user interface information to the client user interface; and
convey the call processing functional information to the call processing configuration manager.

2. The configurable multimedia SIP client of claim 1, wherein the configuration information is included in a configuration file.

3. The configurable multimedia SIP client of claim 1, wherein the configuration information is included in an XML configuration file.

4. The configurable multimedia SIP client of claim 1, wherein the configuration adaptor comprises an XML configuration adaptor.

5. The configurable multimedia SIP client of claim 1, wherein the configuration information includes at least one of a call control key, a call flow instruction, and a SIP message parameter.

6. The configurable multimedia SIP client of claim 1, wherein the configuration information includes call function key information and call flow information.

7. The configurable multimedia SIP client of claim 1, wherein the client user interface comprises a client user interface core, the call processing configuration manager comprises a call processing core configuration manager, and the configuration adaptor comprises an XML configuration adaptor.

8. The configurable multimedia SIP client of claim 1, wherein the configuration adaptor includes an information parser.

9. The configurable multimedia SIP client of claim 1, wherein the configuration adaptor includes an XML parser.

10. The configurable multimedia SIP client of claim 1, further comprising:
a protocol stack coupled to the call processing configuration manager;
a media core coupled to the call processing configuration manager; and
a transport core coupled to the protocol stack and the media core.

11. A configurable multimedia SIP client, comprising:
a client user interface core operable to form a communication interface between a user and the multimedia SIP client;
a configuration adaptor coupled to the client user interface core, wherein the configuration adaptor is operable to read computer-readable configuration setup information, and extract user interface information and call processing functional information from the computer-readable configuration setup information; and
a configuration manager coupled to the client user interface core and the configuration adaptor, wherein the configuration manager is operable to receive configuration information from the configuration adaptor, and create a SIP session with a state machine.

12. The configurable SIP client of claim 11, wherein the client user interface core is further operable to receive function key information, bind the function key information with a call processing core, and create a SIP interface panel including the key function information.

13. The configurable SIP client of claim 11, wherein the client user interface core is further operable to receive function key information, bind the function key information with a call processing core, and create a SIP interface panel including the key function information, wherein the key function information comprises a button to create an Instant Conference.

14. The configurable SIP client of claim 11, wherein the configuration adaptor includes a processor operable to read computer-readable configuration information, and extract function key information and call processing information associated with the function key information from the computer-readable configuration information.

15. The configurable SIP client of claim 11, wherein the configuration adaptor includes a parser operable to read an XML configuration file and parse out configuration information from the XML configuration file.

16. A method for configuring a SIP client, comprising the steps of:
receiving SIP session configuration information; extracting user interface information and call processing functional information from the received SIP session configuration information;
conveying the user interface information to a client user interface core;
conveying the call processing functional information to a call processing core configuration manager;
creating a state machine session with the conveyed call processing information; and
creating a function key with the conveyed user interface information.

17. The method of claim 16, wherein the receiving step and extracting step are performed by an XML configuration adaptor.

18. The method of claim 16, wherein the extracting step is performed by an XML parser.

19. The method of claim 16, wherein the function key comprises an Instant Conferencing session initiation key.

20. The method of claim 16, wherein the SIP session configuration information comprises information in an XML format.
